(19) United States
(12) Patent Application Publication
(10) Pub. No.: US 2008/0232962 A1
(43) Pub. Date: Sep. 25, 2008

(54) TURBOMACHINE AND METHOD FOR ASSEMBLY THEREOF USING A SPLIT HOUSING DESIGN

(76) Inventors: Giridhari L. Agrawal, Simsbury, CT (US); Charles William Buckley, West Hartford, CT (US); Muthusamy Rajendran, Manchester, CT (US)

Correspondence Address: MCCORMICK, PAULDING & HUBER LLP, CITY PLACE II, 185 ASYLUM STREET, HARTFORD, CT, 06103, US

(21) Appl. No.: 12/052,018

(22) Filed: Mar. 20, 2008

Related U.S. Application Data
(60) Provisional application No. 60/919,033, filed on Mar. 20, 2007.

(51) Int. Cl. F01D 25/24; F01D 25/16; B23P 15/04

(52) U.S. Cl. 415/214.1; 415/170.1; 29/888.02

(57) ABSTRACT

The present invention provides an improved design for turbomachinery, such as blowers and compressors, for providing pressurized process gas. The improved design comprises two housing portions that fit together to form an interior cavity in which a preassembled rotating assembly may be installed and balanced. Each housing portion includes an interior compartment designed and shaped to correspond to desired positions of components of the rotating assembly. After the preassembled rotating assembly is seated within the interior compartment of the lower housing portion and balanced, the upper housing portion can be fitted to the lower housing portion to complete the machine housing and encompass and hold the rotating assembly in place without the need to remove or disassemble the rotating assembly. A collector cover can thereafter be attached to the assembled machine housing to enclose an impeller operatively mounted on a rotating shaft of the rotating assembly.

### CROSS-REFERENCE TO RELATED APPLICATION

This application claims the benefit of U.S. Provisional Application No. 60/919,033, filed Mar. 20, 2007, which is incorporated herein by reference.

### FIELD OF THE INVENTION

The field of the present invention generally pertains to the conception, design and manufacture of turbomachinery, such as blowers and compressors, and associated technologies integrating such devices, and more particularly to a split housing design for such turbomachinery that facilitates manufacture and assembly of such devices without compromising performance.

### BACKGROUND OF THE INVENTION

Historically, compressed or pressurized gas has been generated by positive displacement machines and turbomachines, such as, blowers and compressors. Turbomachines are high technology machines that typically involve high engineering, production and assembly costs in order to achieve and maintain desired levels of performance and efficiency with reduced repair and safety concerns. Such high costs are typically due to complex design issues and lengthy assembly procedures.

Attempts are frequently made, with little success, to reduce such costs without affecting performance, operation, or efficiency, and without compromising product safety. One area where costs may be reduced is in the design of the components of the turbomachine. To this end, the present invention provides an improved design that facilitates manufacture of turbomachinery without compromising performance, and permits reduced costs of production and assembling of the turbomachine, as well as increased ease and efficiency of manufacture and assembly, and indeed increased performance.

The most efficient turbomachines utilize and are supported by foil gas bearings. Such machines have shown a tenfold increase in reliability over previous machines using alternative bearing designs. The use of foil gas bearing supported turbomachines have several additional advantages, such as oil free operation, higher efficiency, no scheduled maintenance, high speed operation, quieter operation, and low- and high-temperature capabilities. Accordingly, the use of foil gas bearings in all types of turbomachines is highly desirable as a means of improving the operation and use of such machines, even beyond the traditional fields of use (such as, for environmental control systems of high price aircraft). Applicability, is desirable in many high volume commercial products that can take advantage of more efficiency and reliable operation (such as, blowers and compressors). An overview of foil gas bearing technology is provided in an ASME paper (97-GT-347) by Giri Agrawal, a co-inventor of the present invention.

Use of foil gas bearing supported turbomachines in high volume commercial products, while providing the advantages identified above, has been limited in application due to high production costs, predominantly driven by expenses associated with manufacture, assembly and testing of the components of the machines. The complexity of the machines, due to the use of foil gas bearing technology, also adds to such high production costs. In particular, a standard foil gas bearing supported turbomachine includes a rotating assembly that is supported by at least one journal bearing assembly to accommodate radial load of a rotating shaft. At least one thrust bearing assembly is further used to accommodate the axial load of the rotating shaft during operation. Such turbomachines are extremely sensitive to tolerances, and hence most of the assembly process is manual and requires high tolerance parts. Great care must be taken to balance the components of the rotating assembly during installations, especially the bearing assemblies. For optimum performance, the bearing assemblies must be assembled with close clearance and relative positions with respect to the machine housing, as well as other operable components of the turbomachine, such as the rotating shaft, impellers, and a motor. Typically, a tie rod is used to preload the rotating shaft and all other components of the rotating assembly that rotate within the machine housing during operation. The tie rod further prevents loosening of the parts of the rotating assembly as the shaft is rotating.

During manufacture of turbomachines, the rotating assembly must commonly be balanced as a single assembly—i.e., all operable components must be assembled and mounted on the rotating shaft and placed under preload by the tie rod—often within the machine housing. After balancing and testing of the components, the rotating assembly commonly must be disassembled before final installation in the machine housing. This process results in excess assembly costs and increased manufacture time. Moreover, great care is required in each step of initial assembly, disassembly and installation so that the balancing of the rotating assembly is not affected or any components (especially the bearing assemblies) are not damaged. However, due to repeated handling of the components during this multi-step process, there is an increased risk that some errors may be made between initial balancing and final installation, ultimately leading to poor operation of the machine.

Typically with prior art turbomachinery designs, the rotating assembly is built in the machine housing for balancing and testing in an axial fashion. The machine housing has been assembled and has an interior cavity for accommodating the rotating assembly, with access to the interior cavity being from openings on one or both axial end(s) of the housing. However, accessing the interior cavity in this manner introduces problems, particularly with assembling the rotating assembly in the machine housing. The rotating assembly is typically assembled in a step-by-step fashion, mostly by installing components on the rotating shaft from both axial ends, through the axial openings in the machine housing. For example, the journal bearing assembly is press fit into place within the machine housing, and then the rotating shaft is slid into the machine housing so it can be supported by the journal bearing assembly. The machine housing must be line-bored in this design in order to accommodate the journal bearing assembly in-line. Any displacement, even if slight, will result in failure of the shaft. However, the existing way of inserting a journal bearing assembly, and then sliding the rotating shaft into place requires careful attention so as to not displace any components in any way while other components are subsequently inserted into the machine housing.

After the rotating shaft is positioned within the machine housing, the thrust bearing assembly is installed and moved relative to the shaft using shims. As with the journal bearing assembly, any improper alignment of the thrust bearing assembly with respect to the shaft will result in premature failure of the shaft. In order to achieve optimum clearance and relative positioning between the thrust bearing assembly and the shaft, the shaft typically must be assembled and disassembled several times to adjust the shim so that the thrust bearing assembly can be positioned in the proper location. Care must also be taken when installing other operative components on the shaft within the machine housing, such as impellers and a motor so as not to disturb components already positioned within the housing.

Due to such high tolerance-driven manufacture and assembly procedures of foil gas bearing supported high-speed turbomachines, the cost of production is high and the time for assembly can be lengthy. Commercial products, such as blowers and compressors, which could greatly make use of high-speed foil gas bearing technology, have not previously done so due to such high production costs, and the associated requirement for repeated manual involvement throughout the assembly process.

In order to overcome the complexities involved in manufacturing such turbomachinery and components, an improved design has been invented wherein the rotating assembly may be assembled, balanced and installed into the housing without the need to disassemble any parts of the rotating assembly during balancing of components or for post-balancing installation. This design results in increased simplicity of design, reduced number of parts, reduced assembly cost, and reduced manufacturing time without compromising operation, performance, or safety.

### SUMMARY OF THE INVENTION

The present invention provides a low-cost, split housing design for turbomachinery, such as a blower or a compressor. Such a split housing design also facilitates the manufacturing and assembly process for turbomachines, including machines utilizing foil gas bearing technology to improve operation and efficiency of the turbomachine.

In one aspect of the present invention, a turbomachine is provided that includes a machine housing defining an interior cavity for housing a rotating assembly. The machine housing comprises an upper housing portion and a lower housing portion, each housing portion including a respective interior compartment. The interior compartment of the upper housing portion combines with the interior compartment of the lower housing portion to form the interior cavity when the housing portions are fitted together. The rotating assembly comprises a rotating shaft adapted for rotation about an axis, an impeller mounted on a first end of the rotating shaft for rotation therewith, at least one journal bearing assembly and at least one thrust bearing assembly disposed about the rotating shaft, and a motor including a motor rotor attached to the rotating shaft and a motor stator disposed about the rotating shaft. The shape of the interior cavity generally complements the shape of the rotating assembly.

In another aspect of the present invention, a method for assembling a turbomachine comprises providing an upper housing portion and a lower housing portion, each including a respective interior compartment. The upper housing portion and the lower housing portion are adapted to be joined together to form a machine housing defining an interior cavity. The interior cavity is formed by the respective interior compartments of the upper and lower housing portions when joined together. The method further includes the step of assembling a rotating assembly comprising a rotating shaft adapted for rotation about an axis, an impeller mounted on a first end of the rotating shaft for rotation therewith, at least on journal bearing assembly and at least one thrust bearing assembly disposed about the rotating shaft, and a motor including a motor rotor attached to the rotating shaft and a motor stator disposed about the rotating shaft. The method further includes the steps of seating the preassembled rotating assembly in the interior compartment of the lower housing portion and balancing the rotating assembly as seated within the lower housing portion. Finally, the method includes the step of mounting the upper housing portion onto the lower housing portion to form the machine housing with the interior compartment of the upper housing portion fitting around a portion of the rotating assembly so that the rotating assembly is housed within the interior cavity of the machine housing.

The split housing concept in accordance with the present invention reduces assembly time, number of parts, ease of manufacture and the ease of making modification and repair, resulting in lower machine costs and lower maintenance costs.

The present invention avoids the drawbacks of prior art turbomachine designs, especially during manufacturing and assembly. In particular, the present design avoids the requirement for disassembling the rotating assembly after balancing and testing and before final installation of the rotating assembly. By contrast, the present invention provides the advantage of assembly of the entire turbomachine in fewer assembly steps, thereby reducing the time devoted to assembly and eliminating the concern that errors may be introduced to the construction of the turbomachine between initial assembly, balancing and testing of the rotating assembly and final installation of the rotating assembly. In a preferred embodiment, the rotating assembly is assembled with reduced time involved in checking the relative position of components such as bearing assemblies and a permanent magnet motor on the rotating shaft due to the alignment of components in predefined positions being aided by interior compartments and subcompartments in the split machine housing portions. When the preassembled rotating assembly is seated into the lower housing portion, the structural components of the rotating assembly can be moved and positioned accordingly to occupy a predefined position in appropriately shaped subcompartments. Any required adjustments can be readily made without requiring removal and/or disassembly of the rotating assembly. Once the rotating assembly is positioned and balanced, the upper housing portion is simply placed over the lower housing portion to encompass and hold the rotating assembly in place. Such reduced assembly time also leads to lower assembly costs.

A turbomachine embodying the present invention could be assembled easily by assembling the moving parts of the rotating assembly in one housing portion and finally closing the housing envelope with the other housing portion, and thereafter completing assembly by securing the seam between the two housing portions. The entire turbomachine can be assembled by putting together four main components in a reduced number of assembly steps, namely, an upper housing portion, a lower housing portion, a preassembled rotating assembly, and a collector cover. Assembly of the machine housing along a single seam, or at least a reduced number of seams, means a reduced number of seal points and thus fewer potential points of failure in installation of the rotating assembly and re-assembly of the turbomachine.

The split housing design also improves operation and long-term use of turbomachines incorporating the concepts of the present invention. For example, since the internal features of the machine are open to visual inspection, the accessibility to the interior cavity of the housing to make modification and repairs are considerably improved over prior machine housing designs. Accordingly, the present invention enables a failure proof assembly process that reduces inspection and product rejection costs.

The present invention further has applicability in a variety of fields requiring turbomachinery to pressurize or compress a process gas, including blowers, compressors, generators, turboalternators, and the like, and more particularly, fuel cell systems, hot tub spa systems, food processing units, air knifes, aeration units, printing systems, furnaces, turbocharging devices in automobiles, and other fields or products that heretofore did not make full use of turbomachinery to operate in an efficient manner.

These and other features of the present invention are described with reference to the drawings of preferred embodiments of a blower as an exemplary turbomachine, and its components. The illustrated embodiments of the present invention are intended to illustrate, but not limit the invention.

### BRIEF DESCRIPTION OF THE DRAWINGS

FIG. 1 shows a perspective view of a blower embodying a split housing design in accordance with the present invention.

FIG. 2 shows a cross-sectional view of the blower of FIG. 1.

FIG. 3 shows an exploded perspective view of the blower of FIG. 1, illustrating the internal components of the blower.

FIG. 4 shows an exploded perspective view of the blower of FIG. 1, with the internal components of the blower assembled as a rotating assembly in accordance with the present invention.

FIG. 5 shows a different exploded perspective view of the blower of FIG. 1, with the preassembled rotating assembly of FIG. 4 seated within a lower machine housing portion of the blower.

### DETAILED DESCRIPTION OF THE INVENTION AND PREFERRED EMBODIMENTS THEREOF

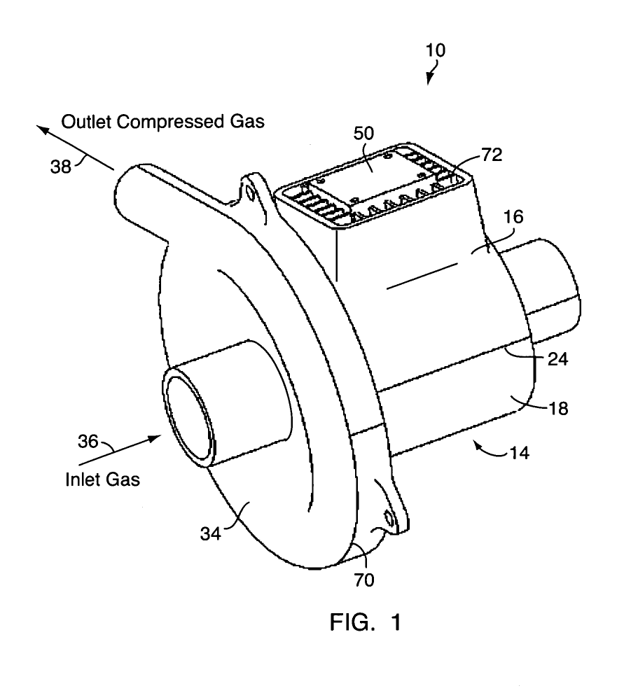

A turbomachine in accordance with the present invention is illustrated in FIGS. 1-5. As shown and described hereinafter, the illustrated turbomachine is a blower, generally designated by reference numeral 10. Though illustrated as blower 10, the present invention has application in all types of turbomachinery know to the person of ordinary skill in the art, such as compressors, generators, turboalternators, and the like. In general, the present invention provides a low-cost, easy to assemble split housing design for turbomachines that facilitates installation and balancing of a rotating assembly disposed within the housing of the turbomachine.

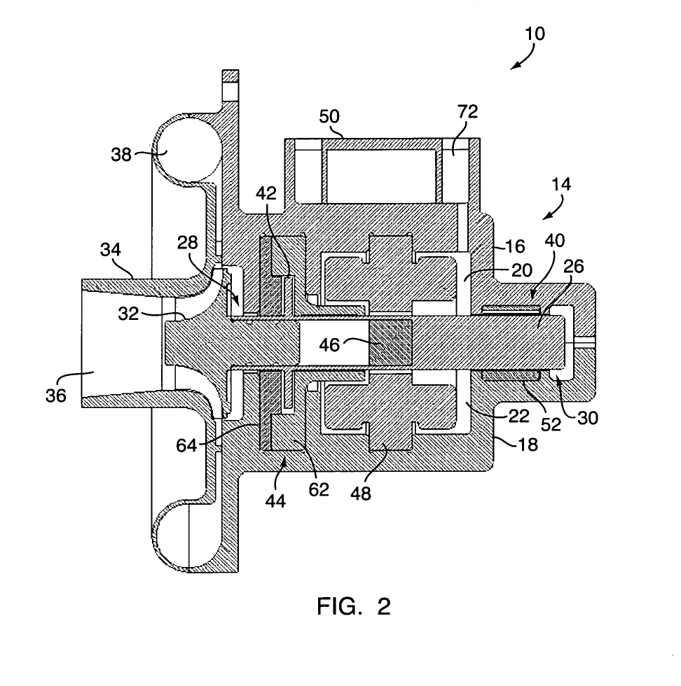

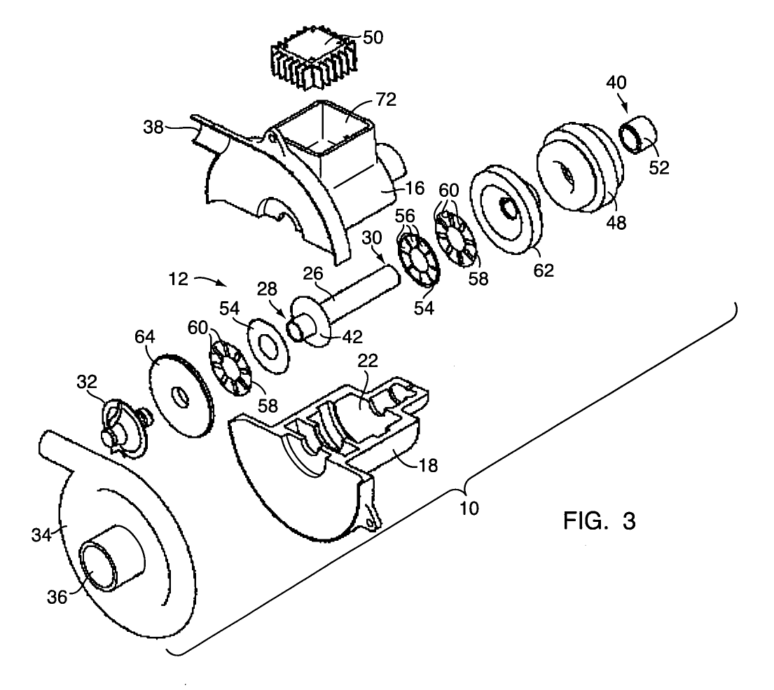

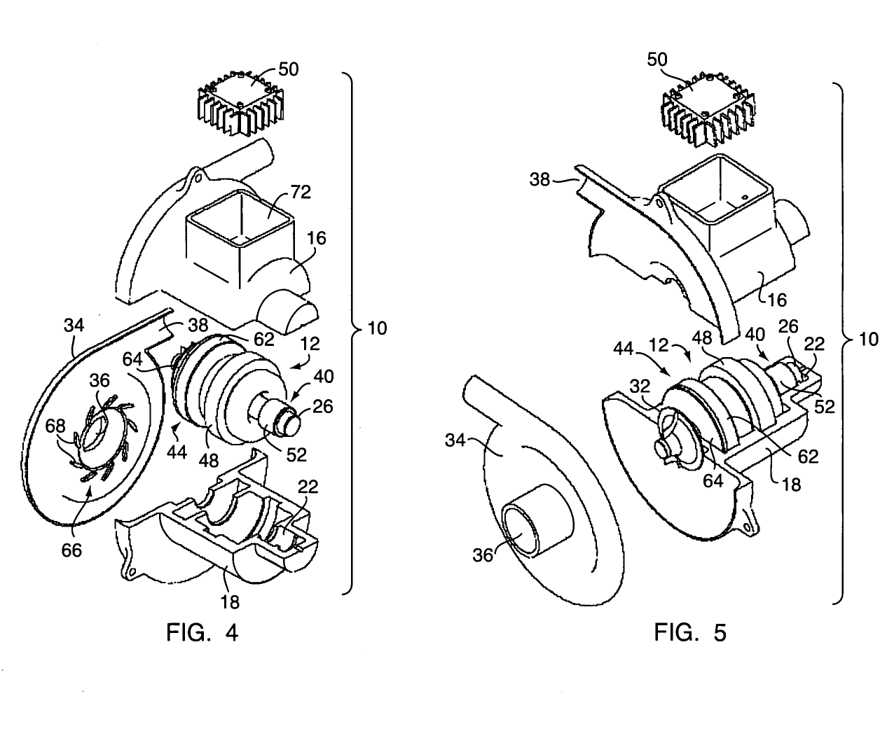

FIG. 1 generally shows a perspective view of an assembled blower 10 incorporating the design concepts of the present invention. FIG. 2 shows a cross-sectional view of the blower 10 of FIG. 1, and provides an illustration of the internal operative components of the blower 10 essentially forming a rotating assembly, described in more detail below and generally designated by reference numeral 12. FIG. 3 shows an exploded perspective view of the blower 10, with the internal operative components forming the rotating assembly 12 in perspective detail. Assembly of the rotating assembly 12, and installation of the preassembled rotating assembly 12 are illustrated in FIGS. 4 and 5.

The blower 10 comprises a machine housing 14 defining an interior cavity to hold and support the rotating assembly 12. As shown in FIG. 3, the machine housing 14 in accordance with the present invention preferably is split into two parts, namely an upper housing portion 16 and a lower housing portion 18. As shown and in preferred embodiments of the present invention, the upper housing portion 16 and the lower housing portion 18 are essentially upper and lower halves of the machine housing 14. Preferably, each housing portion is constructed as a single piece in accordance with desired specification, for example by molding using a desirable material, such as plastics, aluminum and steel. Reducing the parts of the machine housing 14 to essentially two halves, and thereby simplifying the assembly steps for the positioning a rotating assembly within a turbomachine housing reduces manufacturing costs and assembly time, and hence assembly cost as well. Moreover, splitting the housing 14 into two portions in the manner shown and described herein also permits easy access to the interior cavity, in turn facilitating the installation and balancing processes with respect to the rotating assembly 12. Reducing the parts of the blower 10 also creates only a single seam between the housing portions, as opposed to multiple seams throughout the assembled housing.

As constructed, each housing portion 16 and 18 is provided with a respective interior compartment 20 and 22. Preferably, each interior compartment 20 and 22 is complementary shaped—indeed, symmetrical—to one another such that when the housing portions 16 and 18 are fitted together to form the complete machine housing 14, the interior compartments 20 and 22 collectively define the interior cavity to house and hold the rotating assembly 12. More preferably, the combined shape of the interior compartments 20 and 22, and thus as a result the shape of the interior cavity of the complete machine housing 14, is complementary to the design and shape of the rotating assembly 12 so that it sits within the machine housing 14 in accordance with desired specifications, clearances and tolerances to maximize operation and efficiency of the blower 10. Even more preferably, the interior cavity defined by the joined upper housing portion 16 and the lower housing portion 18 is axially symmetrical so as to minimize any undesirable pockets of space or air between the rotating assembly 12 and the machine housing 14.

The machine housing 14 is preferably split in half with a single seam 24, shown more particularly in FIG. 1, extending between the upper housing portion 16 and the lower housing portion 18 along the axial direction of the machine housing 14. In such a design, the axial seam 24 generally aligns with the axis of a rotating shaft 26 of the rotating assembly 12.

As constructed, the upper and lower housing portions 16 and 18 is made with matching axial edges to facilitate joining or fitting the housing portions together. The joining of the housing portions 16 and 18 together forms a complete machine housing 14. The respective interior compartments 20 and 22 combine to form the interior cavity. Preferably, the housing portions 16 and 18 are secured together along the seam 24, after assembly, by vibration welding, or a similar sealing method. Alternatively, the housing portions 16 and 18 can be joined together by fasteners that ensure a secure fitting between the housing portions. The housing portions 16 and 18 may also be joined together by a hinge, creating a clamshell design that can be closed to encompass the rotating assembly, and once closed, sealed by welding or fasteners, if desired. Still alternatively, attachment features can be incorporated into the housing portions 16 and 18 when they are constructed (such as detents in one of the housing portions and cooperating snap fit projections in the other) to facilitate both joining of the two housing portions together, but further to ensure an airtight seal therebetween. In general, any means of joining, and preferably sealing, two parts together known to one of ordinary skill may be used to join the upper housing portion 16 and the lower housing portion 18 together during assembly of the blower 10 of the present invention.

An exemplary design of a rotating assembly to be mounted in the machine housing 14 is shown in FIGS. 2 and 3 and generally designated by reference numeral 12. The rotating assembly 12 comprises a rotating shaft 26 with generally opposing first and second ends 28 and 30, mounted and supported for rotation within the blower 10 about a central longitudinal axis. As illustrated, the central axis of rotation for the rotating assembly 12 is generally aligned with the axial seam 24 of the upper and lower housing portions 16 and 18, described above.

An impeller 32 is mounted at the first end 28 of the rotating shaft 26 for rotation therewith. As discussed in more detail below, the impeller 32 operates relative to a collector cover 34 to pressurize or compress process gas between an inlet 36 and an outlet 38. A hydrodynamic fluid film journal bearing assembly 40 is generally positioned at the opposing second end 30 of the rotating shaft 26. The rotating shaft 26 further includes a radially projecting thrust runner 42 that operates with respect to a thrust bearing assembly 44. The journal bearing assembly 40 in combination with the thrust bearing assembly 44 act to bear the radial and axial loads exerted by the rotating assembly 12, especially at high operating speeds.

The rotating shaft 12 further comprises a permanent magnet motor (more clearly seen in FIG. 2) comprising a motor rotor 46, mounted to, attached to or forming part of the rotating shaft 26, and a motor stator 48 disposed around the rotating shaft 12, and operated by a controller 50 mounted to the machine housing 14. More specifically, the motor rotor 46 is press fit into the rotating shaft 26 at an intermediate position between the opposing ends of the rotating assembly 12, generally between the journal bearing assembly 40 and the thrust bearing assembly 44. The motor stator 48 is supported by the machine housing 14 around the motor rotor 46. As shown, the stator 48 is enclosed in a stator housing that is held in place by the machine housing 14 when the upper housing portion 16 and the lower housing portion 18 are fitted together. In a preferred design, the motor rotor 46 includes a permanent magnet and the motor stator 48 includes coils encircling the motor rotor 46 to operatively interact with the permanent magnet.

Preferably, the journal bearing assembly 40 uses an oil-less, foil gas journal bearing, and more preferably, high spring-rate, high load capacity, hydrodynamic foil gas journal bearing. Generally, the illustrated journal bearing assembly 40 includes a stationary retaining sleeve or bearing housing 52, generally illustrated in FIG. 3 as a separate component to be mounted in the machine housing 14. The retaining sleeve 52 is preferably held in place by the machine housing 14 when the upper housing portion 16 and the lower housing portion 18 are fitted together. The retaining sleeve 52 surrounds and encloses the rotating shaft 26, providing radial support therefore. Together, the retaining sleeve 52 and the rotating shaft 26 define an annular spacing or clearance in which foil elements and resilient elements may be disposed to accommodate rotation of the rotating shaft 26 and handle the radial loads exerted thereby. The illustrated journal bearing assembly 40 may be of the type shown and described in U.S. Pat. No. 7,070,330, having a common assignee herewith and incorporated herein by reference.

The thrust bearing assembly 44 of the present invention preferably uses oil-less foil gas bearings, and more preferably, high spring-rate, high load capacity, hydrodynamic foil gas thrust bearings. Such foil gas bearings have numerous performance, maintenance and operating advantages over conventional bearings for turbomachines, as discussed briefly in the Background Section above. The illustrated thrust bearing assembly 44 may be of the type shown and described in U.S. Pat. No. 6,948,853, having a common assignee herewith and incorporated herein by reference. Generally, the illustrated thrust bearing assembly 44 includes the thrust runner 42 having an annular-shaped portion projecting radially from and circumscribing the rotating shaft 26. As shown in FIG. 3, the thrust runner 42 is a part of the rotating shaft 26. The thrust runner 42 may alternatively comprise a separate component, including a hub that may slide over the rotating shaft 26 so that the thrust runner 42 is capable of rotation in coordination with rotation of the rotating shaft 26.

Typically, the thrust runner 42 has first and second opposed axial sides, which act as thrust carrying surfaces. In a preferred design, at least one thrust bearing is provided on a respective axial side of the thrust runner 42. Each thrust bearing includes a thrust bearing plate 54 with multiple top foils 56 disposed thereon, and a spring plate 58 with multiple leaf springs or flat springs 60 disposed thereon, as shown in the exploded view of FIG. 3. In operation, each thrust bearing plate 54 and spring plate 58 are preferably kept stationary within the machine housing 14 relative to the thrust runner 42 to aid in distribution of axial loads. As so designed, the thrust bearing assembly 44 supports and transmits the axial load of the rotating assembly 12 through the entire assembly in a distributed fashion. In the present invention, the thrust bearing assembly 44 further includes a thrust bearing housing comprising a thrust cavity 62 and a thrust cap 64 that join together to form an enclosed region to hold the thrust bearings in place with respect to the thrust runner 42 during rotating of the rotating shaft 26. The thrust runner 42 accordingly rides over the thrust bearings during rotation and takes the axial load of the rotating assembly 12. The thrust bearing housing is held in place by the machine housing 14 when the upper housing portion 16 and the lower housing portion 18 are fitted together.

Though foil-type hydrodynamic bearings are preferred for efficient operation of the blower 10 of the present invention, the split housing design described herein may also be used with ball-type friction journal bearings and/or thrust bearings to take radial and axial loads exerted by the rotating assembly 12.

The rotating assembly 12 of the blower 10 is assembled separately and then directly seated into the lower housing portion 18 for balancing and testing. As illustrated more clearly in FIGS. 4 and 5, the interior compartment 22 of the lower housing portion 18 has shape and volume generally complementing the shape and volume of a predefined construction rotating assembly 12, much like puzzle pieces fitting together. Thus, the preassembled rotating assembly 12 can be readily fitted into the lower housing portion 18 in accordance with desired clearances and accounting for desired tolerances to be experienced during operation of the blower 10. The rotating assembly 12 is therefore assembled without any necessity to check the relative position of components such as the bearing assemblies 40 and 44 and the motor on the shaft 26. That is, the interior compartment 22 of the lower housing portion 18 essentially dictates the positioning of the components. Each component has a predefined position in the housing 14, preferably defined by a respective subcompartment precisely shaped to the design of each component. For example, a subcompartment formed in the lower housing portion 18 complements the shape of the stator housing. A separate subcompartment complements the shape of the thrust bearing housing. Similarly, a subcompartment complements the shape of the journal bearing retaining sleeve. Openings are likewise formed in the interior compartment 22 to accommodate the rotating shaft 26. Each of the subcompartments are also separated by walls of projections that space the subcompartments and thus the structural components of the rotating assembly 12 to be housed therein according to predefined, optimally balanced positions. When the preassembled rotating assembly 12 is dropped into the lower housing portion 18, the components can be moved accordingly to occupy the predefined spaces within the housing 14. This method of assembly saves a great deal of time normally spent assembling a rotating assembly checking the positioning of the components, disassembling the rotating assembly if something is off, and then repeating the steps, often several times before the rotating assembly is completely balanced.

The upper housing portion 16 likewise has an interior compartment 20 with separated subcompartments that are shaped to receive structural components of the preassembled rotating assembly 12 when the upper housing portion 16 is joined to the lower housing portion 18. In the illustrated split housing design, the interior compartment 20 of the upper housing portion 16 mirrors the interior compartment 22 of the lower housing portion 18. In this design, the rotating assembly 12 fits tightly in the machine housing 14, and components intended to be held stationary within the machine housing 14 are held in place, while rotating components can operate without undesired interference. If the design of the rotating assembly 12 changes (for example, to add an extra journal bearing assembly or an extra impeller), the shape of the interior compartments of the upper and lower housing portions 16 and 18 can likewise be changed so as to ensure ideal fit of the rotating assembly 12 within the conjoined housing portions.

During assembly of the rotating assembly 12, the motor rotor 46 is press fit into the shaft 26 and a thrust bearing comprising a spring plate 58 and a top foil thrust bearing plate 54 is slid over the first end 28 of the shaft 26 toward and into position with respect to the thrust runner 42. The thrust cap 64 is thereafter slid over the thrust bearing and the first end 28 of the shaft 26 is covered with the impeller 32, which is preferably press fit into position. Another thrust bearing, again comprising a spring plate 58 and a top foil thrust bearing plate 54, is slid over the second end 30 of the shaft 26, and the thrust bearing is held in place with respect to the thrust runner 42 by attaching the thrust cavity 62 to the thrust cap 64. The motor stator 48 is thereafter slid over the second end 30 of the shaft 26 and positioned around the motor rotor 46. Finally, the journal bearing assembly 40 is slid onto the rotating shaft 26 and positioned at the second end 30 thereof.

Once the rotating assembly 12 has been assembled, it is seated in the lower housing portion 18 for balancing and testing. Once the rotating assembly 12 has been balanced to desired specifications, the upper housing portion 16 is mounted onto and attached to the lower housing portion 18, thereby housing and holding the rotating assembly 12, with close tolerance, within the interior cavity defined between the two portions of the machine housing 14. Preferably, the seam 24 between the housing portions 16 and 18 is sealed, such as by vibration welding to eliminate the risk of leaks from the machine housing 14 during operation.

As so assembled and manufactured, the assembly time and cost is significantly reduced due to the use of the split housing design of the present invention. In particular, once the rotating assembly 12 is seated within the lower housing portion 18, it can be balanced and checked in its desired end position. If everything checks out okay, then the rotating assembly 12 no longer needs to be removed and/or disassembled from the machine housing 14. Instead, the upper housing portion 16 is simply attached to the lower housing portion 18 to complete the machine housing 14 and enclose the preassembled, prebalanced and pretested rotating assembly 12.

The illustrated blower 10 further includes a collector cover 34 that includes the axial process gas inlet 36 and partially defines the process gas outlet 38 along its periphery. The outlet 38 of the blower 10 is preferably formed by a half pipe formed in the collector cover 34 and a corresponding half pipe formed in the upper housing portion 16. As shown in FIG. 4, a diffuser 66 is formed into or attached to the collector cover 34 with diffuser vanes 68 extending radially about the axial inlet 36. Preferably, the diffuser 66 is integrated into the collector cover 34 so that the diffuser vanes 68 are embedded into the collector cover 34. Additionally, the diffuser 66 and vanes 68 are aligned with the impeller 32 so that the flow of air through the diffuser 66 in association with rotation of the impeller 32 is optimized.

The collector cover 34 is attached to the machine housing 14 after the upper and lower housing portions 16 and 18 are fitted together. More particularly, the collector cover 34 is attached to the end of the housing 14 and forms the inlet and outlet for the impeller 32. A seam 70 between the collector cover 34 and the machine housing 14 is sealed, much in the same manner as the axial seam 24 between the two housing portions 16 and 18. Preferably, the collector cover seam 70 is sealed by vibration welding to prevent leakage of process gas.

In operation of the blower 10, the impeller 32 rotates close to the collector cover 34 without touching it, also maintaining close clearance to reduce leakage losses. When rotating, the impeller 32 draws a process gas into the blower 10 through the axial inlet 36. The process gas is pressurized or compressed as it passes through the diffuser vanes 68 and the impeller blades. Once processed, the gas is delivered to the outlet 38. During operation of the blower 10, a small amount of process gas may be leaked through the machine housing 14 to cool the bearings and the induction motor.

The controller 50 is assembled separately and fitted into a controller recess 72 formed in the upper housing portion 16 of the blower 10. The controller 50 controls operation of the motor, which in turn controls rotation of the rotating shaft 26 and the impeller 32. For example, when the controller 50 is energized, high frequency current is passed through the motor stator 48 and produces rotating magnetic field in a coil, which in turn interacts with the permanent magnet of the motor rotor 46 and causes shaft rotation. The shaft rotation creates centrifugal force in the impeller 32 resulting in gas flow through the collector cover 34 and pressure rise of a process gas.

The above described blower 10 and components can be assembled by simply putting together just four essential pieces, namely, an upper housing portion 16, a lower housing portion 18, a preassembled rotating assembly 12, and a collector cover 34. As so designed, assembly time of the blower 10 is reduced. Also, with a single axial seam 24 between the upper and lower housing portions 16 and 18, and a single radial seam 70 between the assembled machine housing 14 and the collector cover 34, the locations for leakage or failure of the machine housing 14 are reduced, and provided that the seams 24 and 70 are properly sealed (e.g., by vibration welding), the machine housing 14 can be quickly and easily assembled in an airtight manner.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A turbomachine, comprising:
a machine housing defining an interior cavity, said machine housing comprising an upper housing portion and a lower housing portion, each said housing portion including a respective interior compartment, the upper and lower interior compartments combining to form the interior cavity when the upper and lower housing portions are fitted together;
a rotating assembly disposed within the interior cavity, comprising:
a rotating shaft adapted for rotation about an axis;
an impeller mounted on a first end of the rotating shaft for rotation therewith;
at least one journal bearing assembly disposed about the rotating shaft;
at least one thrust bearing disposed about the rotating shaft; and
a motor including a motor rotor attached to the rotating shaft and a motor stator disposed about the rotating shaft;
wherein shape of the interior cavity generally complements the shape of the rotating assembly.

2. The turbomachine according to claim 1, wherein the upper and lower housing portions fit together along a seam extending in an axial direction generally parallel to the axis of rotation of the rotating shaft.

3. The turbomachine according to claim 2, wherein the axial seam between the upper and lower housing portions is co-planar with the axis of rotation of the rotating shaft so that approximately half of the rotating assembly is seated within the interior compartment of the lower housing portion and approximately half of the rotating assembly is seated within the interior compartment of the upper housing portion.

4. The turbomachine according to claim 1, wherein the interior cavity is generally axially symmetrical.

5. The turbomachine according to claim 1, further comprising a collector cover mounted to an axial end of the machine housing and defining an axial process gas inlet, wherein said collector cover includes a diffuser with diffuser vanes extending radially about the axial inlet and being operatively aligned with the impeller of the rotating assembly.

6. The turbomachine according to claim 5, wherein the diffuser is integral with the collector cover such that the diffuser vanes are embedded into the collector cover.

7. The turbomachine according to claim 5, wherein the collector cover and the upper housing portion combine to define a process gas outlet.

8. The turbomachine according to claim 1, wherein the rotating shaft includes a radially projecting thrust runner, and the at least one thrust bearing assembly comprises:
at least one thrust bearing axially adjacent the thrust runner and including a thrust bearing plate having a plurality of foils disposed thereon, and a spring plate having a plurality of springs disposed thereon; and
a thrust bearing housing comprising a thrust cavity and a thrust cap that join together to form an enclosure to hold the at least one thrust bearing;
wherein the thrust bearing housing is held by the machine housing when the upper and lower housing portions are fitted together.

9. The turbomachine according to claim 1, wherein the at least one journal bearing assembly comprises:
a stationary retaining sleeve having an inner surface defining a cylindrical opening for receiving the rotating shaft;
at least one foil element disposed within the cylindrical opening; and
at least one resilient element disposed within the cylindrical opening;
wherein the stationary retaining sleeve is held by the machine housing when the upper and lower housing portions are fitted together.

10. The turbomachine according to claim 1, further comprising a controller operatively connected to the motor stator is mounted to the machine housing.

11. The turbomachine according to claim 1, wherein a recess is formed into the upper housing portion for holding the controller.

12. The turbomachine according to claim 1, wherein the interior compartment of the lower housing portion comprises subcompartments associated with structural components of the rotating assembly, including at least each of the impeller, thrust bearing assembly, motor stator, and journal bearing assembly, to locate each component at a predefined position along the length of the rotating shaft.

13. The turbomachine according to claim 12 wherein the subcompartments are separated by projections that space the structural components of the rotating assembly in accordance with the predefined positions.

14. The turbomachine according to claim 13 wherein the interior compartment of the upper housing portion is symmetrical to the interior compartment of the lower housing portion.

15. A method for assembling a turbomachine, comprising:
providing an upper housing portion including an interior compartment;
providing a lower housing portion including an interior compartment, wherein the upper housing portion and the lower housing portion are adapted to be joined together to form a machine housing defining an interior cavity, said interior cavity being formed by the respective interior compartments of the upper housing portion and the lower housing portion;
assembling a rotating assembly comprising:
a rotating shaft adapted for rotation about an axis;
an impeller mounted on a first end of the rotating shaft for rotation therewith;
at least one journal bearing assembly disposed about the rotating shaft;
at least one thrust bearing disposed about the rotating shaft; and
a motor including a motor rotor attached to the rotating shaft and a motor stator disposed about the rotating shaft;
seating the preassembled rotating assembly in the interior compartment of the lower housing portion;
balancing the rotating assembly as seated within the lower housing portion; and
mounting the upper housing portion onto the lower housing portion to form the machine housing with the interior compartment of the upper housing portion fitting around a portion of the rotating assembly so that the rotating assembly is housed within the interior cavity of the machine housing.

16. The method according to claim 15, wherein the interior compartment of the lower machine housing further includes subcompartments associated with structural components of the rotating assembly, including at least each of the impeller, thrust bearing assembly, motor stator, and journal bearing assembly, so that the balancing step comprises locating each component at a predefined position along the length of the rotating shaft in accordance with a predefined subcompartment.

17. The method according to claim 15, further comprising the step of sealing a seam formed between the upper housing portion and the lower housing portion when mounted together.

18. The method according to claim 15, further comprising the step of mounting a collector cover to an axial end of the machine housing, wherein said collector cover includes a diffuser operatively aligned with the impeller.

19. The method according to claim 18, wherein the collector cover further defines an axial process gas inlet, and further defines, in combination with the upper housing portion, a process gas outlet.

20. The method according to claim 15, further comprising the step of operatively connecting the motor to a controller, wherein said controller is mounted to the upper housing portion.
